(19) United States
(12) Patent Application Publication
(10) Pub. No.: US 2013/0057181 A1
(43) Pub. Date: Mar. 7, 2013

(54) DISTRIBUTED CONTROL INTELLIGENT LIGHTING ARRAY

(71) Applicants: Bruce Vincent Ward Bernard, Burnaby (CA); Martin Albert Unrau, Burnaby (CA)

(72) Inventors: Bruce Vincent Ward Bernard, Burnaby (CA); Martin Albert Unrau, Burnaby (CA)

(73) Assignee: CARMANAH TECHNOLOGIES CORP., Victoria, BC (CA)

(21) Appl. No.: 13/636,109

(22) PCT Filed: Apr. 7, 2010
(86) PCT No.: PCT/CA2010/000511

§ 371 Date: Nov. 20, 2012

(51) Int. Cl. H05B 37/02

(52) U.S. Cl. 315/312

(57) ABSTRACT

An array of lights in which a coordinator collects sensed lighting transition times from each light in order to determine and select a median transition time. The individual light having the selected transition time assumes control of the lighting array, controlling and synchronizing the light transitions of the array, until the coordinator collects another group of transition times and appoints a new synchronization leader.

### FIELD OF THE INVENTION

This invention relates to arrays of solar-powered lights in which each light senses local light conditions to control its operation. In particular this invention relates to the synchronization of the various lights in such arrays.

### BACKGROUND OF THE INVENTION

The synchronization of the operation of individual lights in an array of solar-powered lights ensures that the array works in a coordinated manner and minimizes disruptive visual effects. Examples of such arrays include parking lots, street lamps on a given street, walkways, runways and parks.

In a wired lighting array, a designated photocell can detect a transition from day to night and cause a signal to be transmitted over the array to activate the various lights. The arrangement can also control the deactivation of the lights when sufficient ambient light is detected. Because wired arrays can be difficult to install and maintain, particularly over wide areas or in remote areas, wireless lighting arrays are often preferred. However, it can be difficult to achieve the same level of synchronization between the lights in a wireless array as is possible in a wired array.

The simplest way to achieve coordination in a wireless array is to pre-program the lights in the array to turn on at a given time, say 6:00 p.m., and to turn off at another given time, such as 8:00 a.m. The given times for each day can be pre-programmed or changed as the year passes, to account for changes in the local daylight hours throughout the year. However, this can result in wasted energy, if the programmed activation time is earlier than actual dusk, or if the deactivation time is later than sunrise. Conversely, setting the activation time to be later than dusk, or the deactivation time to be earlier than sunrise, can result in unsafe conditions, as can particularly cloudy days, when an activation time earlier than actual sunset might be preferred. Achieving a high level of coordination between the wireless lighting array and the actual lighting conditions can be very difficult, requiring ongoing adjustment of the lighting parameters as local sunrise and sunset times change throughout the year.

Many lighting arrays therefore use an arrangement comprising a photocell associated with each light to determine whether the local conditions around a given light dictate that the light should be on or off. This ensures that the lights are generally coordinated with the actual lighting conditions, and avoids wasting energy while providing light when it is needed. However, since each photocell reacts only to conditions in its immediate vicinity, detection of an accurate day to night or night to day transition can be affected by physical objects and shadows around the light such that each light in the array may activate and deactivate at different times. Activating an array of lights under those conditions can be a patchy process and not aesthetically pleasing to an observer. Other factors, such as differences between the lights arising from variations in componentry can also affect the synchronization of the various lights in the array.

It is known in the prior art to coordinate lighting instructions to the lights in a wireless array of lights so as to bring any lights that are not synchronized back into agreement with the other lights in the array.

U.S. Pub. No. 20040100396 discloses a method of synchronizing marker lights wherein a central controller collects information from individual lights and informs a remote operator of the status of the lights. The central controller is programmed with a master reference. If any lights are outside the master reference by more than a programmed tolerance, the light is automatically re-synchronized to the master signal. If the system finds it is not possible to re-synchronize the light, an alarm is raised.

U.S. Pat. No. 7,369,462 describes a wireless controller which transmits signals to synchronize slave devices, such as a time display or a switching device to activate a device, such as a lock, an alarm or a light. The master device receives GPS timing signals, which it uses to set an internal clock and then sends to all of the slave devices along with operating instructions. The slave devices then set their own internal clocks and execute the instructions once the clocks match the time specified in the instructions.

In such systems, a preset master controller synchronizes the array. The controller is preset to a master reference or has an internal clock, to which all of the lights must conform. However in such cases, the controller remains unresponsive to unanticipated changes to light conditions, such that the time signals being sent may not accurately reflect the needs of the light array as a whole. For example, if there is a widespread lighting change, such as a thunderstorm or solar eclipse, which darkens the area at an unexpected time, a preset master controller is unlikely to be able to respond appropriately. It would therefore be useful to provide a control system that considers the actual light readings and conditions around the lights in providing instructions to the overall array, rather than simply forcing all lights to adhere to a pre-programmed lighting cycle or to the light level readings established by a remote master controller. Further, it would be useful to be able to synchronize the lights based on a comparison of the actual readings provided by the lights themselves, in order to ensure that any widespread conditions are dealt with appropriately.

In addition to activation and deactivation commands, it would be useful to provide a lighting array that can consider local conditions, such as sensed temperature or pressure, snow, rain, wind, humidity or particular contaminants, to determine whether the lighting array should be activated in particular coordinated pattern. For example, the lights may be synchronized to flash in a particular order or pattern, or to flash a different colour if the temperature drops below freezing, as this would be useful to warn people using an associated walkway or runway of the potentially icy conditions.

It is therefore an object of this invention to provide a lighting array that overcomes the foregoing difficulties.

These and other objects of the invention will be better understood by reference to the detailed description of the preferred embodiment which follows. Note that not all of the objects are necessarily met by all embodiments of the invention described below or by the invention defined by each of the claims.

### SUMMARY OF THE INVENTION

According to the invention, a particular light assembly in the array is pre-designated as the coordinator, with the ability to allocate and shift synchronization leadership from time to time among the assemblies of the array.

The sensors associated with each light assembly sense any one or more of several local ambient conditions, such as: light levels, time of light transition between thresholds, temperature, pressure, wind, vibration, particular contaminants, rain, snow or humidity.

The sensor readings are collected by the coordinator, which may analyze the information in order to determine which light has the most representative reading of the assemblies in the array (for example by determining which light sensor has provided the median value of sensor readings). That assembly is then designated the synchronization leader and is given synchronization control over the array based on its own sensor readings, for a pre-determined period of time. For so long as that assembly remains the synchronization leader, all of the lights in the array follow the instructions given by it, thereby synchronizing the operation of the array regardless of the individual sensor readings of any other assembly.

The object of the synchronization may be the activation and deactivation of the lights in the array, but may also be flash patterns or the colour of the lights in the array.

The coordinator can also monitor whether the sensor readings received from any given light differs from the median value by a significant amount, in which case an operator or investigator can be alerted.

The system of the invention allows for adaptive and distributed control over the array and ensures that any outlying light is brought into synchronization with the array, despite any variation in its locally determined transition times, in a manner that is responsive to overall lighting conditions around the lighting array.

The principles of the invention are also applicable to the control of other variable operational parameters for the light assemblies to ensure uniform control of the parameters over the entire array.

In one of its aspects, the invention comprises a lighting array comprising a plurality of light assemblies, each of the assemblies having a light source, and communication means for communicating the value of an operational parameter of the assembly to a coordinator; the coordinator being configured to: receive the values; and compare the values to determine a median value. The assembly that communicated the median value may then act as coordinator for the determination of a subsequent median value calculation. The array may comprise means for communicating to an operator a deviation from the median value, such as a recorded log of the deviation.

In further aspects of the invention, the coordinator may be configured to cause each assembly of the array to conform the operational parameter to the value of the operational parameter at the assembly that communicated the median value. The coordinator may be configured to communicate to the light assemblies to instruct them to synchronize the operational parameter to that of the assembly that communicated the median value and to receive synchronization data from the assembly that communicated the median value. The coordinator may be configured to cause each assembly of the array to conform the operational parameter to the value of the operational parameter at the assembly that communicated the median value for at least a predetermined period of time. The coordinator may be configured to communicate to the light assemblies to instruct them to synchronize the operational parameter to that of the assembly that communicated the median value and to receive synchronization data from the assembly for at least a predetermined period of time. The coordinator may be one of the light assemblies or may be a dedicated coordinator.

In yet a further aspect of the invention, each of the lighting assemblies may be configured to synchronize to the output of a sensor associated with itself in the absence of a communication from the coordinator after a predetermined period of time.

In another aspect, the invention comprises a method of synchronizing a lighting array comprising the steps of receiving a value for an operational parameter from each of a plurality of lighting assemblies; comparing the values to determine a median value; and appointing the lighting assembly which communicated the median value to synchronize the lighting array. The value may comprise an activation time, deactivation time, the time of onset of dusk or the time of onset of dawn. The method may comprise the step of communicating to an operator a deviation from the median value, such as by recording a log of the deviation.

In a further aspect, the method may comprise the step of appointing another lighting assembly to synchronize the lighting array after a predetermined period of time.

In a further aspect of the invention, the steps of the method may be performed by a coordinating one of the lighting assemblies and the coordinating one is selected by comparing unique addresses associated with each of the assemblies.

In a further aspect, the steps may be performed by a coordinating one of the lighting assemblies, a sensor is associated with the coordinating one and for an initial period of time in the operation of the array, the coordinating one provides a synchronization signal to the assemblies of the array based on the sensor.

In yet another aspect of the invention, the operational parameter may be selected from the group of parameters comprising: activation time, deactivation time, onset of dusk, onset of dawn, or from the group comprising battery charge levels, solar panel charge readings, solar panel voltage readings, collected solar power levels, battery temperature readings, light source temperature readings, and signal strength.

The foregoing was intended as a broad summary only and of only some of the aspects of the invention. It was not intended to define the limits or requirements of the invention. Other aspects of the invention will be appreciated by reference to the detailed description of the preferred embodiment and to the claims.

### BRIEF DESCRIPTION OF THE DRAWINGS

The invention will be described by reference to the detailed description of the preferred embodiment and to the drawings thereof in which:

FIG. 1 is a schematic of the components of the lighting array;

FIGS. 2A and 2B show a flowchart of the operation of the lighting array; and

FIGS. 3A and 3B are a flowchart of an alternate embodiment of the lighting array.

### DETAILED DESCRIPTION OF THE PREFERRED EMBODIMENT

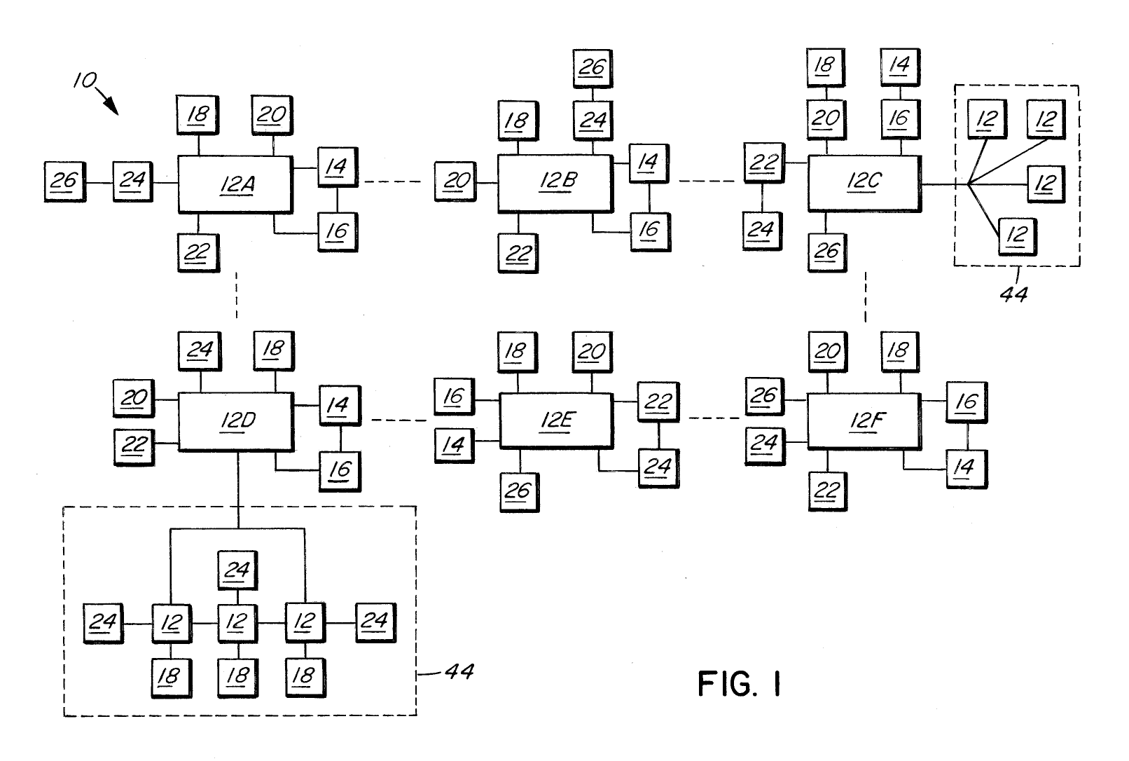

Referring to FIG. 1, the lighting array 10 comprises a plurality of light assemblies 12 that, in the preferred embodiment, are to be coordinated, such that they activate and deactivate at the same time.

In FIG. 1, the array 10 is shown as consisting of six light assemblies, labelled 12A through 12F, although it will be understood that the array 10 may comprise any desired number of assemblies 12. The array 10 may further comprise one or more subgroups 44 of assemblies, for which assemblies 12A-12F may act as gateways with the rest of the array.

The lighting array 10 is placed in any location in which coordinated lighting is desired, for example, but not limited to, parking lots, walkways, airport runways and park areas. Each of light assemblies 12 of the preferred embodiment comprises a solar panel 14, a rechargeable battery 16, a light source 18, a GPS module 20, and a sensor bank 22. Each assembly 12 comprises communications means represented by module 24 to allow communication between the assemblies 12 by any appropriate means, wired or wireless, depending on the nature and size of the lighting array, such as cellular signal, Bluetooth, WiFi, Zigbee, GSM, etc., as appropriate. Each assembly 12 is associated with a unique address 26 by which it can be distinguished from other assemblies in the array.

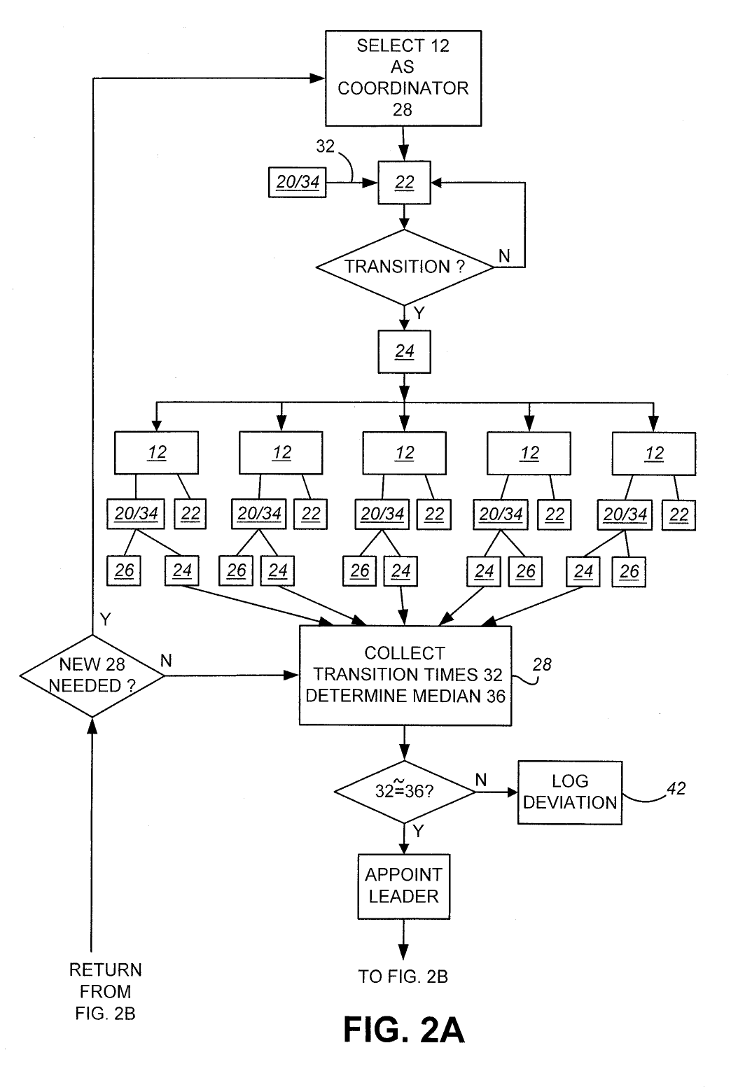

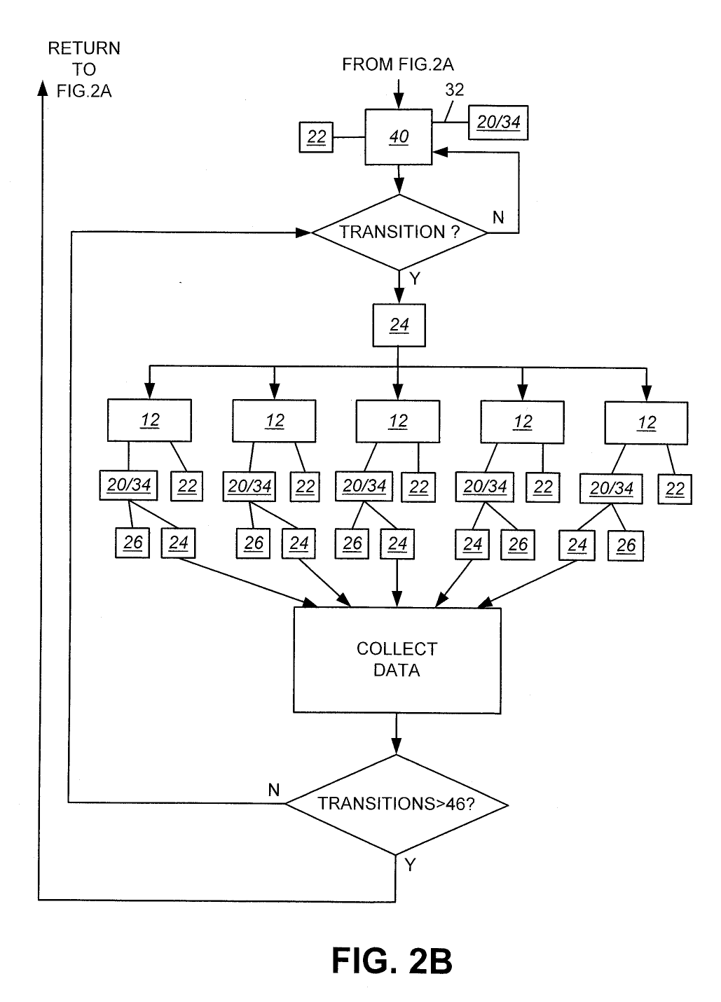

In operation, as best shown in FIGS. 2A and 2B, a specific assembly 12 is pre-designated as the coordinator 28. In the preferred embodiment, upon initial configuration, each of the assemblies in the array queries other assemblies within communications range to determine which has the highest address 26, which is then designated as the interim coordinator 28. Once all assemblies in the array have participated in the exchange, the identity of the coordinator is confirmed. It will be appreciated that the coordinator 28 may also be selected based on other suitable criteria, such as the lowest address 26.

Once a coordinator 28 is selected, it assumes control of the array 10 for a pre-determined amount of time. In the preferred embodiment, the coordinator maintains that status for the life of the array, unless it becomes inactive or malfunctions, or if new lights are added to the array.

For an initial predetermined operating period, coordinator 28 uses its own sensor bank 22 to detect a lighting (day-to-night or night-to-day) transition and therefore to determine an appropriate activation or deactivation time for the members of the array. The coordinator then sends a transition command, instructing all other assemblies 12 to transition by activating or deactivating, as appropriate. The transition command, sent via communications module 24, preferably carries a time stamp 32, so that the other assemblies 12 can determine the time of the message. The time stamp 32 may be provided by any suitable means, such as GPS module 20 or a real-time clock 34 installed in each of the assemblies 12.

Each assembly 12 also detects its own local transition time, using its own sensor bank 22 to detect the transition and GPS module 20 or real-time clock 34 to detect the time of the transition, and communicates the data to coordinator 28 via communications module 24. The communication includes the unique address 26 of the assembly 12, in order to allow the coordinator 28 to identify the assembly 12 sending each transition time, and to ensure that all assemblies 12 are reporting.

Coordinator 28 collects the transition times, and determines the median value 36 of the group of transition times. As an example, the array 10 of six assemblies 12A-12F could each detect dusk at a different time, such that coordinator 28 could collect six different activation times, as shown in Table 1:

TABLE 1
Collected Transition Times

| Assembly | Activation Time |
|---|---|
| 12A | 5:37:23 PM |
| 12B | 5:38:37 PM |
| 12C | 5:36:52 PM |
| 12D | 5:34:03 PM |
| 12E | 5:39:34 PM |
| 12F | 5:36:55 PM |

Given these readings, the coordinator 28 would determine that the reading received from assembly 12A or 12F is the median activation time. If there is an odd number of assemblies 12 in the array 10, and each transition time is distinct, the median value is simple to determine. In a situation where two assemblies 12 could be the median value, such as where there are an even number of assemblies 12 or where there are two or more identical time stamps, the initial coordinator 28 may select the median assembly 12 using any appropriate criteria, such as the assembly 12 with the highest or lowest address 26, or the earlier or later time 32, or the lamp located geographically closest or furthest from coordinator 28.

If, in the example shown, the coordinator 28 is pre-programmed to select the median value of the assembly having the earliest activation time, then light 12F would be chosen as the synchronization leader 40. For the next transition time, assembly 12F becomes the synchronization leader and sends the transition command to the other assemblies over communications module 24, which in this case would be a deactivation command that occurs when assembly 12F determines that the sun has risen, based on its own sensor bank 22 readings. Again, the transition command, sent via communications module 24, preferably carries a time stamp 32 provided by means such as GPS module 20 or a real-time clock 34, so that the other assemblies 12 can determine the time of the message.

Assembly 12F may be designated the synchronization leader 40 for a predetermined timeframe 46, which may be real time, e.g. 24 hours, or a selected number of transitions, following which coordinator 28 begins to collect another group of times 32, in order to determine a new median transition time 36 and to determine a new synchronization leader 40. The predetermined timeframe 46 can be changed according to the needs of the array 10 and the operator programming it.

A benefit of the intelligent distribution of the control of the lighting array 10 over the various assemblies 12 is that problems with one specific assembly 12 can be avoided. For example, generally an array 10 would be distributed over an area such that the transition times are expected to be on the order of a few minutes apart, rather than over an hour apart. Therefore, if the coordinator 28 receives the transition times shown in Table 2, it can be presumed that light 12E has some sort of technical problem that prevents it from determining or communicating a transition time similar to those received from other assemblies 12 in the array 10.

TABLE 2
Collected Transition Times

| Assembly | Transition Time |
|---|---|
| 12A | 5:37:23 PM |
| 12B | 5:38:37 PM |
| 12C | 5:36:55 PM |
| 12D | 5:34:03 PM |
| 12E | 4:32:49 PM |
| 12F | 5:36:52 PM |

The collector 28 can be programmed by the operator to log 42 certain deviations in the collected transition times 36. In this case assembly 12E would be logged, such that the operator would know that 12E must be checked, to verify and correct any technical problems. Technical problems that could lead to erroneous transition time readings include a fault with the assembly 12E or any of its components; poor positioning of the assembly 12E with respect to buildings, plants or other physical objects in the area; or misalignment of the solar panel.

In some situations, an assembly 12 may not receive a transition command from synchronization leader 40 within a period of time after detecting its own local transition time. Such a period may be pre-selected by the operator. In that case, assembly 12 could query coordinator 28 regarding whether a transition command has already been sent. If a transition command has already been sent, coordinator 28 confirms this fact, allowing assembly 12 to immediately perform the transition. The fact of the missed communication may be logged 42 by coordinator 28 for later review by the array operator.

If assembly 12 does not receive a response to its query from coordinator 28, it may use communications module 24 to send the same query to one or more other assembly 12 in the array 10, in order to ensure that the communications modules 24 are functional. If no responses are received, assembly 12 may be default programmed to immediately transition, based on its own local transition time detected by sensor bank 22. This autonomous mode of operation will preferably continue until communications module 24 is repaired and/or communications over array 10 can be restored.

In the case of a communications failure with one or more assemblies 12, the coordinator 28 would also preferably realize that not all of assemblies 12 are reporting transition times, and would log 42 the problem so that an operator could investigate the matter.

In another embodiment, coordinator 28 can collect information from the assemblies 12 other than or in addition to transition times 32, as an indicator of the general state of the array. For example, battery charge levels, solar panel 14 charge and voltage readings, or collected solar power levels can also be used to determine whether an assembly 12 and its associated solar panel 14 are properly positioned to receive a sufficient amount of sunlight to keep the battery 16 charged to an acceptable level. Temperature readings for the battery 14 or light source 18 can be used to identify overheating or other functional problems with the battery 14 or light source 18. Signal strength readings for the communications module 24 can be used to identify problems with the module 24 itself, or may indicate a physical blockage of the signal, such as a newly-erected building or newly planted tree between the light 12 and the coordinator 28. In each situation, the coordinator 28 would log the readings, allowing the operator to verify and correct the problem.

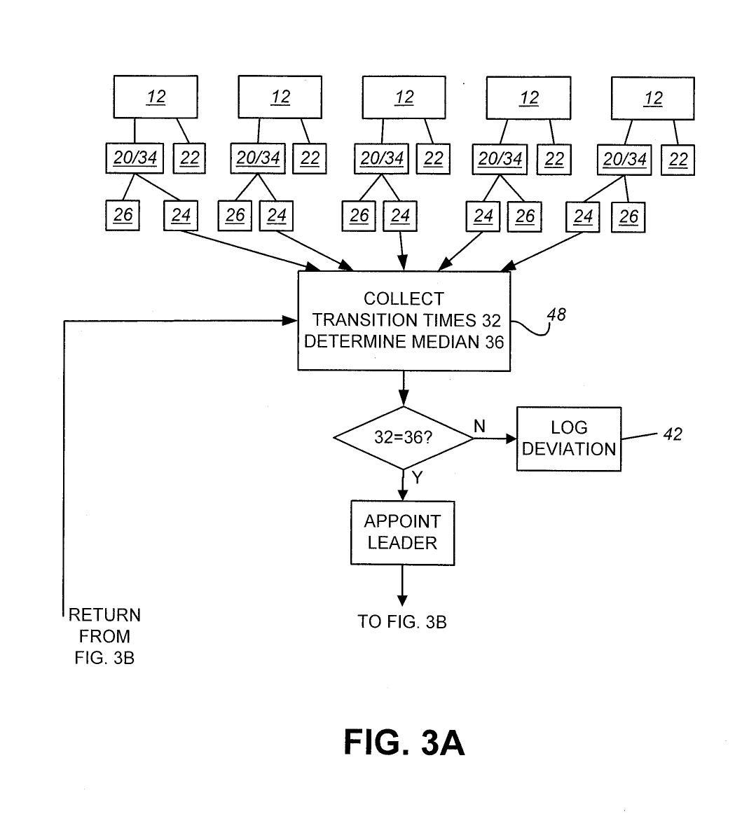

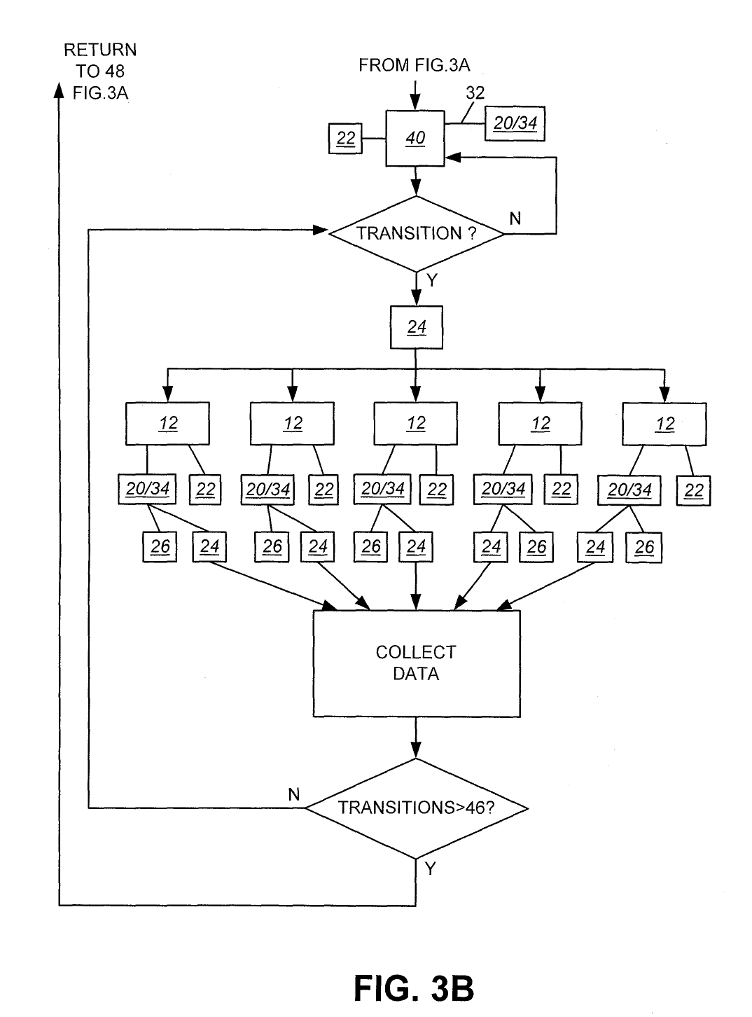

In an alternative embodiment, shown in FIGS. 3A and 3B, the array 10 may comprise a dedicated coordinator 48, which performs the functions of the coordinator 28 described above, as far as gathering transition times 32, determining the median time 36 and appointing a synchronization leader 40, but does not comprise an assembly 12, and may or may not comprise other components of the assemblies 12, such as solar panel 14, rechargeable battery 16, light source 18, GPS module 20 or sensor bank 22.

Exactly when and how the coordinator 28 receives information from the assemblies 12 in the array 10 can also be adjusted to avoid noise and collisions the communications between the coordinator and the assemblies 12. In one embodiment, each assembly 12 can communicate its transition time as it happens, and the coordinator 28 simply collects the times as they are received. The coordinator 28 can wait until it has received information from each of the expected assemblies 12, determine the median transition time, appoint the synchronization leader, and wait until the next expected transition. Alternatively, the coordinator 28 can wait until it has received a statistically significant portion, such as half, of the expected number of readings from assemblies 12 before determining the median value. This may allow for a more timely transition, particularly if one or more lights 12 is reporting much later than the others, or if a large number of assemblies 12 are reporting at the same time and the coordinator does not receive all of the signals.

As noted above, it is expected that the assemblies 12 in a typical array 10 will be experiencing transition times relatively close together. In situations where there are a large number of assemblies 12, this can create a large number of signals being sent to the coordinator 28 at roughly the same time. Some of the signals could interfere with others, causing the coordinator 28 to receive fewer signals than expected. This may result in an unnecessary malfunction alert being stored or sent to the operator. In addition, the noise of the signals being transmitted from the assemblies 12 may interfere with the signal from the coordinator 28, such that the assemblies 12 or synchronization leader 40 do not receive their instructions from the coordinator 28 in a timely manner.

Accordingly, in an alternate embodiment, the time of collecting information from the assemblies may be offset from the anticipated transition times. Each assembly 12 may be programmed to wait for a designated amount of time before sending its last transition time to the coordinator 28, avoiding the problem of all assemblies 12 talking to the coordinator 28 at once and ensuring that all assemblies 12 are only receiving instructions at the transition times. In another alternative embodiment, the coordinator 28 may be programmed to poll the assemblies 12 individually or in smaller groups, avoiding interference and noise. The polling times can be offset from the anticipated transition times, ensuring that all assemblies 12 are able to receive instructions at the appropriate time.

In yet a further embodiment that takes full advantage of the concept of distributed intelligence, the roles of coordinator and of synchronization leader may be exercised by the same lighting assembly. Apart from transmitting synchronization signals for the predetermined time a given assembly is the synchronization leader, the given assembly may also perform the functions of the coordinator, including after the predetermined time assessing the data from the various assemblies, determining a median value and its associated assembly and passing on the functions of both synchronization leader and coordinator to the new median assembly. This embodiment requires that each lighting assembly 12 comprise the software needed to perform the coordination functions described in this disclosure.

It will be appreciated by those skilled in the art that the preferred and alternative embodiments have been described in some detail but that other modifications may be practiced without departing from the principles of the invention.

1. A lighting array comprising:
a plurality of light assemblies, each of said assemblies having a light source, and communication means for communicating the value of an operational parameter of said assembly to a coordinator;
said coordinator being configured to:
receive said values; and
compare said values to determine a median value.

2. The array of claim 1 wherein said coordinator is further configured to cause each assembly of the array to conform said operational parameter to the value of said operational parameter at the assembly that communicated said median value.

3. The array of claim 1 wherein said coordinator is configured to communicate to said light assemblies to instruct them to synchronize said operational parameter to that of said assembly that communicated said median value and to receive synchronization data from said assembly that communicated said median value.

4. The array of claim 3 wherein said coordinator is one of said light assemblies.

5. The array of claim 4 wherein said operational parameter is a parameter selected from the group of parameters comprising: activation time, deactivation time, onset of dusk, onset of dawn.

6. The array of claim 3 further comprising means for communicating to an operator a deviation from said median value.

7. The array of claim 6 wherein said means for communicating to an operator comprises a recorded log of said deviation.

8. The array of claim 1 wherein said operational parameters are selected from the group of operational parameters comprising: battery charge levels, solar panel charge readings, solar panel voltage readings, collected solar power levels, battery temperature readings, light source temperature readings, and signal strength.

9. The array of claim 1 wherein said coordinator is configured to cause each assembly of the array to conform said operational parameter to the value of said operational parameter at the assembly that communicated said median value for at least a predetermined period of time.

10. The array of claim 1 wherein said coordinator is configured to communicate to said light assemblies to instruct them to synchronize said operational parameter to that of said assembly that communicated said median value and to receive synchronization data from said assembly for at least a predetermined period of time.

11. A method of synchronizing a lighting array comprising the steps of:
receiving a value for an operational parameter from each of a plurality of lighting assemblies;
comparing said values to determine a median value; and
appointing the lighting assembly which communicated the median value to synchronize the lighting array.

12. The method of claim 11 wherein said value comprises an activation time, deactivation time, the time of onset of dusk or the time of onset of dawn.

13. The method of claim 11 further comprising the step of communicating to an operator a deviation from said median value.

14. The method of claim 13 wherein said step of communicating to an operator comprises recording a log of said deviation.

15. The method of claim 11 further comprising the step of appointing another lighting assembly to synchronize the lighting array after a predetermined period of time.

16. The method of claim 11 wherein said steps are performed by a coordinating one of said lighting assemblies and said coordinating one is selected by comparing unique addresses associated with each of said assemblies.

17. The method of claim 11 wherein said steps are performed by a coordinating one of said lighting assemblies, a sensor is associated with said coordinating one and for an initial period of time in the operation of the array, said coordinating one provides a synchronization signal to the assemblies of the array based on said sensor.

18. The array of claim 3 wherein each of said lighting assemblies is configured to synchronize to the output of a sensor associated with itself in the absence of a communication from the coordinator after a predetermined period of time.

19. The method of claim 11 wherein said operational parameter is selected from the group comprising: battery charge levels, solar panel charge, solar panel voltage, solar panel power, temperature of a battery, temperature of a light source, signal strength.

20. The array of claim 3 wherein said assembly that communicated said median value acts as coordinator for the determination of a subsequent median value calculation according to claim 1.
